(19) United States
(12) Patent Application Publication
(10) Pub. No.: US 2007/0265912 A1
(43) Pub. Date: Nov. 15, 2007

(54) System and method for tracking advertising effectiveness using redeemable incentives

(75) Inventors: Roger Robert Belanger, Dover, NH (US); Thomas Bowen Clarke, Durham, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/430,659

(22) Filed: May 9, 2006

(51) Int. Cl. G06Q 30/00

(52) U.S. Cl. 705/14

(57) ABSTRACT

A method for tracking advertising effectiveness includes printing advertising data with an advertisement, the advertising data identifying the advertisement, the advertising data capable of being scanned by a handheld device of a potential customer. The potential customer is provided with an incentive to scan the advertising data, the advertising data related to the incentive being stored on the handheld device after scanning by the potential customer. The advertising data scanned by the potential customer is received, and as a consequence a loyalty point program of the potential customer is credited. A system and other method is also provided.

The present invention relates generally to printed materials with advertising and to handheld devices such as scanners for scanning printed materials.

U.S. Pat. Nos. 6,448,979 and 6,753,883, both hereby incorporated by reference herein, describe printed medium activated interactive communication of multimedia information, including advertising. A scanner and a receiver, which may be a single device, communicate with a portal server to play multimedia sequence information received from the portal server. Advertisements may be printed with a machine readable code such as a barcode including a high density bar code and the data from the code may be read by the scanner. The code contains link information corresponding to provider information and may be an alphanumeric sequence. The sequence may activate and result in the playing of multimedia sequence information. The scanner the receiver or the portal server can translate the link information into a network address, so that the multimedia sequence information can be played. Additionally or in the alternative, the network address information can point to a file containing executable computer code and displayed on the receiver or scanner. The system contemplates using additional code types such as benefit redemption information, rebate information and coupon information. The system may also collect and manage code that lacks link information, such as a UPC code. The person can take the UPC information home and get information on the product, a coupon, or other benefit redemption information.

User input information may be stored in the scanner memory. A communications bridge can send the link information and the user input information to the receiver and via a network to the portal server. The system also is capable of allowing print advertisers to track their impressions to execution and to collect demographic information about the person performing the scan through a tracking module. The tracking module is further capable of tracking the transaction value of e-commerce transactions originating from a specific publication, type of publication, or provider and calculate fee percentages based on the transaction. The scanner may have clock which can track the time the ad was scanned.

U.S. Pat. No. 6,896,182 is also incorporated by reference herein and describes a card verification system in which a card identification code is registered. A read unit reads the card identification code from the card. A verification apparatus verifies the card only when an existing place of the read unit belongs to an area corresponding to the card identification code. The card is a card used for settlement, and is used when the card identification code is read by the read unit. The use place of the card is coincident with the existing place of the read unit. By adding the use place of the card to a verification condition of the card, unjust use of the card can be prevented. This patent also describes a mobile remote operation point-of-sale terminal as disclosed in Japanese Laid Open Patent Application (JP-A-Heisei 11-500550). In an accounting system, a portable radio accounting terminal is provided in which a user inputs transaction data of dealings using keypad, a UPC bar code of the goods is read by a CCD sensor, a credit card, a debit card and a smart card of the user can be read. The portable radio accounting terminal transmits the dealings and card data to a central network controller via a radio communication network. The central network controller transmits to the host computer in the accounting facilities which processes the card data and the dealings in real time in order. The accounting facilities sends back confirmation data to the central network controller and send back to the radio accounting terminal via the radio communication network. Thus, the radio accounting terminal issues the printed receipt of the dealings to the user.

### SUMMARY OF THE INVENTION

The present invention provides a method for tracking advertising effectiveness comprising:

printing advertising data with an advertisement, the advertising data identifying the advertisement, the advertising data capable of being scanned by a handheld device of a potential customer;

providing the potential customer with an incentive to scan the advertising data, the advertising data related to the incentive being stored on the handheld device after scanning by the potential customer; and

receiving the advertising data scanned by the potential customer and as a consequence crediting a loyalty point program of the potential customer.

The present invention also provides a system for tracking advertising effectiveness comprising:

a loyalty point collection server receiving information related to scanned advertising data of an advertiser, the scanned advertising data being stored on a plurality of handheld devices, the loyalty point collection server crediting loyalty points to loyalty point programs of users of the handheld devices as a function of the scanned advertising data, the loyalty point collection server providing information on the scanned advertising data to the advertiser.

### BRIEF DESCRIPTION OF THE DRAWINGS

The present invention will be described further with respect to the drawings in which:

FIG. 1 shows a schematic of one embodiment of a system of the present invention;

FIG. 2 shows a schematic of one embodiment of a system of the present invention; and

FIG. 3 shows a flowchart of a method of the present invention.

### DETAILED DESCRIPTION

Reference is first made to U.S. patent application Ser. Nos. 11/388,173 and 11/387,953, filed Mar. 23, 2006, both of which are hereby incorporated by reference herein.

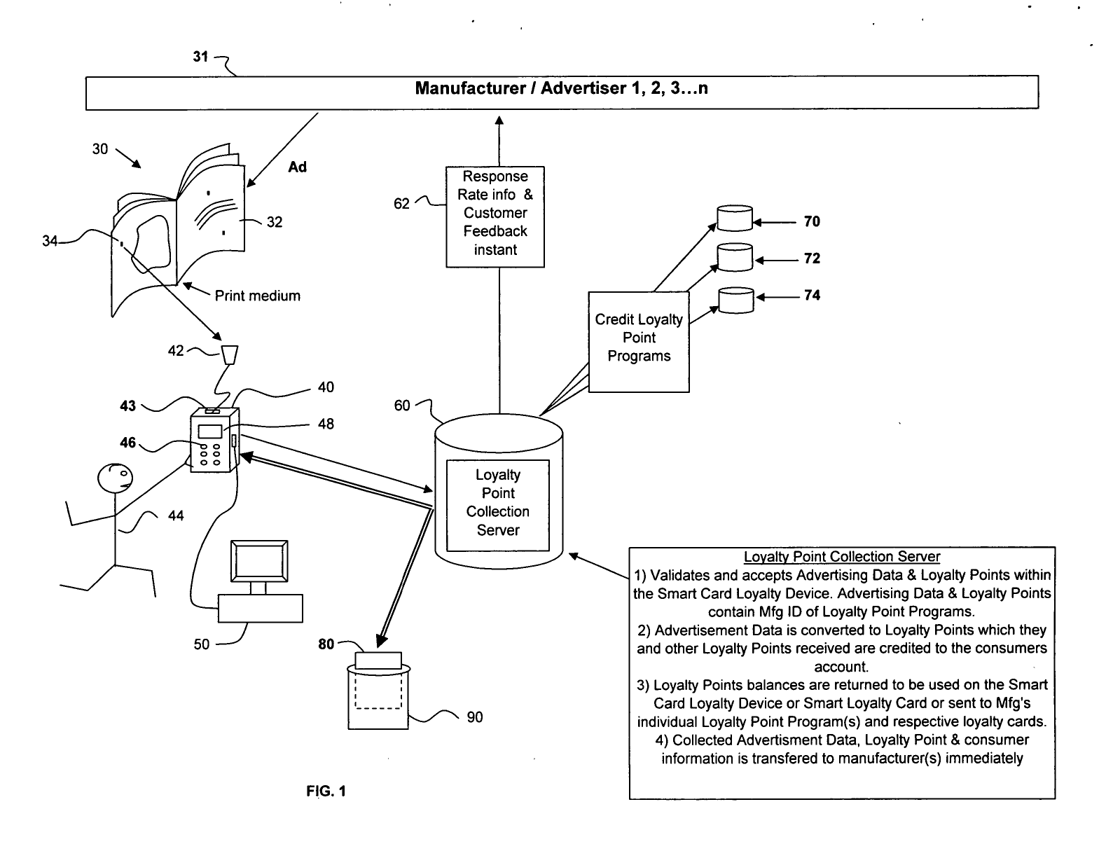

FIG. 1 shows a general overview of one embodiment of the present invention. An advertisement 32 from an advertiser 31 is printed for example in a magazine 30. Advertising data 34, such as the magazine name, page and advertiser identification information can be provided, for example in a code form as described in incorporated by reference U.S. Pat. No. 6,448,979. A potential customer 44 has a handheld device 40 for example an IPOD from Apple, or cell phone, the handheld device having a detachable or integrated scanner 42 capable of scanning the printed advertising data 34, for example printed in the form of a 2-dimensional (2-D) bar code, and inputting the advertising data into a memory of the handheld device 40. The scanner 42 may be attached via an interface 43.

Each scanned advertising data 34 can provide the potential customer 44 with an increase in loyalty points for a loyalty points program 70 of the potential customer. For example, the scanned advertisement may be for an airline which advertises that the scan will provide an extra 50 frequent flyer miles for the potential customers frequent flyer program. The customer 44 can then link to a home computer 50, for example via a USB link or infrared link. The customer can then access for example a secure website of the airline where the frequent flyer miles account is shown, and mouse click on a window button so that the scanned advertisement data stored on the handheld device related to the airline is downloaded to a loyalty point collection server 60 of the airline. The customer's account can then be credited and the advertising data sent to the airline, here the advertiser 31, as shown by link 62. The airline thus knows that that particular frequent flyer account holder read and scanned a particular advertisement, for example a TIME magazine advertisement shown on Jun. 6, 2006 on page 5. Information beneficial to the airline, for example on types of publications a particular frequent flyer account holder reads and the response rates for advertisements can then be accumulated. This information can be tied into already known data such a purchase patterns of the account holders, and analyzed for improving advertising effectiveness. For example, it may be found that frequent flyer account holders reading TIME magazine spend more money on purchasing actual flights from the advertising airline than those reading another magazine and thus advertisements in TIME magazine may be more valuable, and the value may be quantified to some extent.

In the embodiment described above, a click on the website will start a search of the database of the handheld device for advertising data related to the airline. For example, the advertising data for a particular airline could start with a unique 5 digit code and any advertising data for that particular airline is then downloaded to the server 60. The data can then be erased from the handheld device. The loyalty point collection server 60 and/or handheld device 40 may provide duplicative scanning prevention can then ensure that the potential customer does not receive loyalty points for the same add scanned twice.

As opposed to the mouse click embodiment, the advertising data also may be sent to the server 60 from the handheld device 40 so that for example the customer 44 can scroll via an input device 46 on the handheld device 40 through the stored advertising data, for example via display information shown on a display 48. The display information is a function of the advertising data, and additional information may be obtained for example through interface of the handheld device with a server having display information. For example, the name of the airline may appear for a particular stored advertising data and the customer then can push a button on an input device 46 of the handheld device 40 to send the advertising data to the server 60.

The server 60 can then validate and accept the sent advertising data. In this embodiment, the server can have duplication prevention so that a single advertisement from one customer can only be accepted once. The user or handheld device can erase the advertising data, since the user knows that the same data will not be accepted again. The sent data may include actual scanned data as well as additional data such as a time when the advertisement was read.

Advertiser 31 can then determine the effectiveness of the advertisement 32, for example by monitoring scan rates for different publications. The advertiser can also determine the effectiveness of the incentive information associate therewith. For example, the airline can print 10,000 ads stating that a scan will be worth 10 loyalty points, and 10,000 ads stating that a scan will be worth 20 loyalty points, and provide advertising data indicating which of the ads are worth 10 points and which are worth 20 points. The advertiser can then see if the value change alters the response rate to the ads.

The advertiser 31 also can track redemption of the loyalty points.

The present invention permits excellent incentive for a customer to provide advertising data. Feedback from the loyalty programs can be almost instantaneous.

In the FIG. 1 embodiment, the loyalty point collection server need not be a server controlled by the advertiser, and the loyalty point program need not be the loyalty point program of the advertiser. For example, the NEW YORK TIMES offers readers a loyalty program called TIMESPOINTS, and this newspaper could thus print the advertising data 34 for all of its advertisements, and manage the loyalty point server 60. The newspaper then could provide response rate feedback via link 62 to each advertiser, and provide the potential customer with an increase in the customer's TIMESPOINTS loyalty points.

A printing press manufacturer for magazines or newspapers also could manage the loyalty point collection server 60 and store information on all the advertising data. For example, GOSS INTERNATIONAL CORPORATION could manage the server 60 and provide information to the advertisers 31 and also manage interaction with a plurality of loyalty points programs 70, 72, 74 of the customer 44. For example, the collection server 60 could provide a central point for the customer to manage all of the customer's loyalty points programs and require a single password access, and may for example have a single website, such as www.gossspot.com. Thus when the customer would scan an airlines, cereal and pharmacy store advertisements, and then access the central website and click a mouse, the advertising data from the handheld device would be downloaded and loyalty points for the specific airline advertisements would be assigned to the airline frequent flyer program 70, for the cereal advertisements to a cereal loyalty program 72, and for the pharmacy store advertisements to a pharmacy store loyalty program 74. Each program account can be viewed on the user's account at the central website, as the advertisers participating in the advertising program are cooperating with the loyalty point collection server manager.

Alternate to the crediting of electronically-stored loyalty points programs, the loyalty points could also be sent to a smart loyalty card 80 via a loyalty card interface device 90, which can be for example at a kiosk or connected to the user's home computer. Thus the smart loyalty card 80 as opposed to the user's electronic loyalty points account stores the loyalty points.

As an example, the smart loyalty card may be a restaurant loyalty points card. After a meal, the customer has a bill of $50.00 and via scanning has had $5 worth of loyalty points added to the loyalty card 80. The customer gives both the loyalty points card and a credit card to the restaurant, and the loyalty card is reduced by $5 and the credit card is charged $45. In this way, the advertiser, in this case the restaurant, can also gain information on the purchase patterns of advertisement readers. It should also be noted that the advertisement data 34 may be a coupon. Even if the coupon is not used for value redemption (for example it is expired or the customer does not clip or otherwise redeem the coupons), the coupon can be converted into use with a loyalty points program.

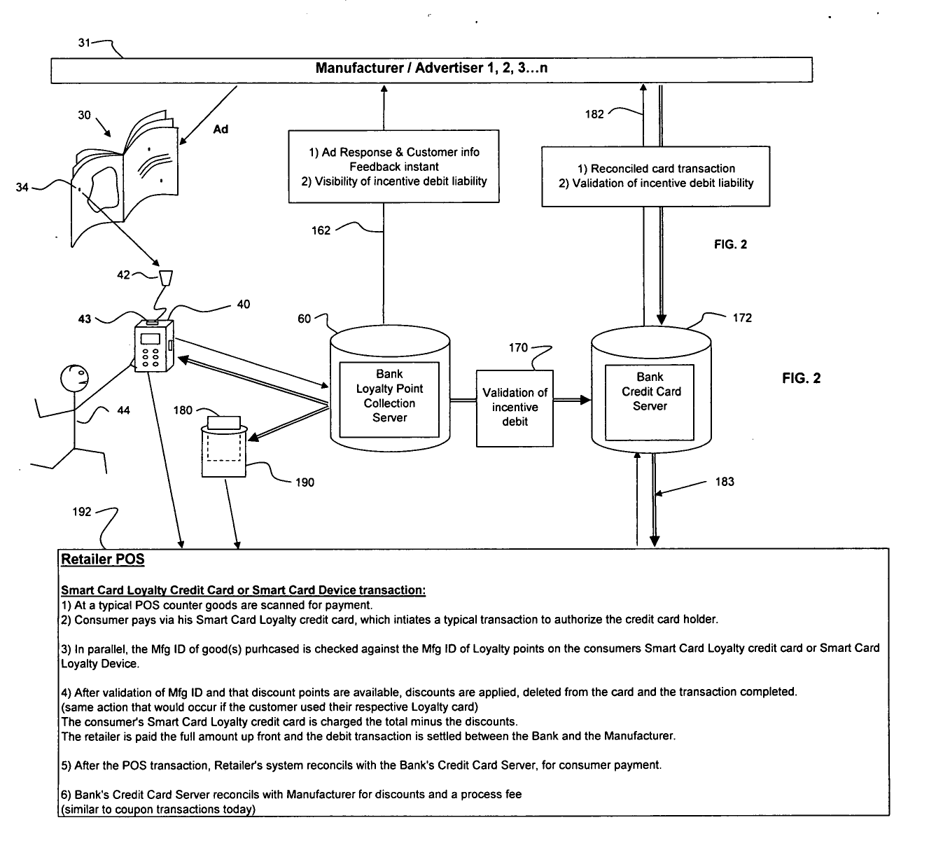

FIG. 2 shows an embodiment with the loyalty points program integrated with a credit or debit or other payment card 180, which preferably is a smart card having a chip readable by a point of sale device in addition to the standard magnetic card strip. The chip can store a loyalty points value for one of more loyalty points programs. Therefore, at a point of sale the smart card loyalty credit card or a similar smart card device such as a cell phone with an integrated credit card and a smart chip may be used for both the e-commerce transaction and incentive reduction. Advertisers 31 may have agreed to pay a credit card issuer, for example a bank, to receive advertising data or to provide a discount to the user when the user actually purchases a good.

In parallel, the server 160 adds any loyalty points for individual loyalty programs to the customer's smart card loyalty credit card 180 or smart card device 40. The points are thus stored on the smart chip in the card 180 or device 40. Therefore the customer can now use such smart card or device at any point of sale device without having to validate points with a server 172, or 160 at a point of sale (POS).

In parallel, the Mfg ID of goods(s) purchased is checked against the Mfg ID of Loyalty points on the customer's smart card loyalty credit card or device. After validation of the Mfg ID and that discount points are available on the smart chip, discounts are applied, points are deleted from the card and the transaction completed.

From the transaction, the customer's smart card loyalty credit card 180 is charged the total minus the discount.

The retailer is paid the full amount up front and the discount debit transaction is settled between the Bank and the manufacturer.

After the POS transaction, retailer's system reconciles with the Bank's credit card server 172 via link 183 for customer payment. Thereafter, the Bank's credit card server 172 reconciles with the manufacturer 31 for discount debits and a process fee via link 182.

When the card holder purchases a good at a point of sale 192, the bank card server 172 is only used to validate the customer ID, similar to the way credit cards are used today. Therefore, at the point of sale the store receive the full amount of the transaction. The customer's credit card is charged the full amount minus the discount. The retailer's system reconciles with the Bank's server for full payment, and the card issuer server 172 reconciles with the advertiser 31 via a link 182, and then thereafter the debit liability is canceled.

As an example, at a point-of-sale grocery store the card user 44, who previously had scanned advertisements from a cereal manufacturer worth $6 in loyalty point value, has a food bill equal to $95. $50 of that bill is for the cereal of the cereal manufacturer. At checkout with a loyalty credit card, customer credit and ID is validated via card server 172, the cereal manufacturer ID is checked against the loyalty points stored on the loyalty credit card. The $6 discount is then applied at checkout, so that the incentive debit of $6 is erased, and the customer pays $89. The grocery store receives $95 dollars from the credit card company (minus any fees), and the credit card company receives $6 from the advertiser 31.

It is noted that by synchronizing the server 160 with the bank commerce credit card server, via link 170, fraud prevention can be provided. In other words, the server 160 can store loyalty point information regarding a specific smart card 180, and ensure that the points redeemed on card 180 do not exceed those issued previously by the server 160. The retailer can be notified and the transaction stopped. The server 172 also can store debit information of the advertisers related to the loyalty points, via link 170, so that these can be checked for fraud. Thus if for example a total amount of debit points being redeemed exceeds the amount issued, the transactions can be stopped.

An alternate method is where the loyalty points are not stored on a smart loyalty credit card, but rather solely on server 160, which for example permits use of a credit card without a smart chip. When the card holder purchases a good at a point of sale 190, the bank card server 172 knows the card information via link 183 and checks the loyalty point server 160 or other database storing the incentive debit via a link 170 and reduces the purchase price for the good the amount of the debit liability. The point of sale, for example a store, can still receive the full amount. When the card issuer server 172 reconciles with the advertiser 31 via a link 182, the debit liability is canceled.

As an example, at a point-of-sale grocery store the card user 44, who previously had scanned advertisements from a cereal manufacturer worth $6 in loyalty point value, has a food bill equal to $95. $50 of that bill is for the cereal of the cereal manufacturer. At checkout with a loyalty credit card, the credit card server 172 validates that that amount is acceptable, and the cereal manufacturer ID is checked against the loyalty points stored in server 160. The $6 discount is then applied at checkout, so that the incentive debit of $6 is erased, and the customer pays $89. The grocery store receives $95 dollars from the credit card company (minus any fees), and the credit card company receives $6 from the advertiser 31.

Advertisers 31 can set limits on the amount of discounts, for example 10% of the purchase price, so that in the above example, only $5 of the $6 worth of loyalty points would be credited to the customer, and $1 would remain in the loyalty account.

Also, if the advertiser and the point-of-sale store or location are the same, the link 182 may be eliminated and the point-of-sale location reimbursed with the reduced amount, in the above example $89 dollars.

The FIG. 2 embodiment tracks actual sales as well, which can be highly advantageous.

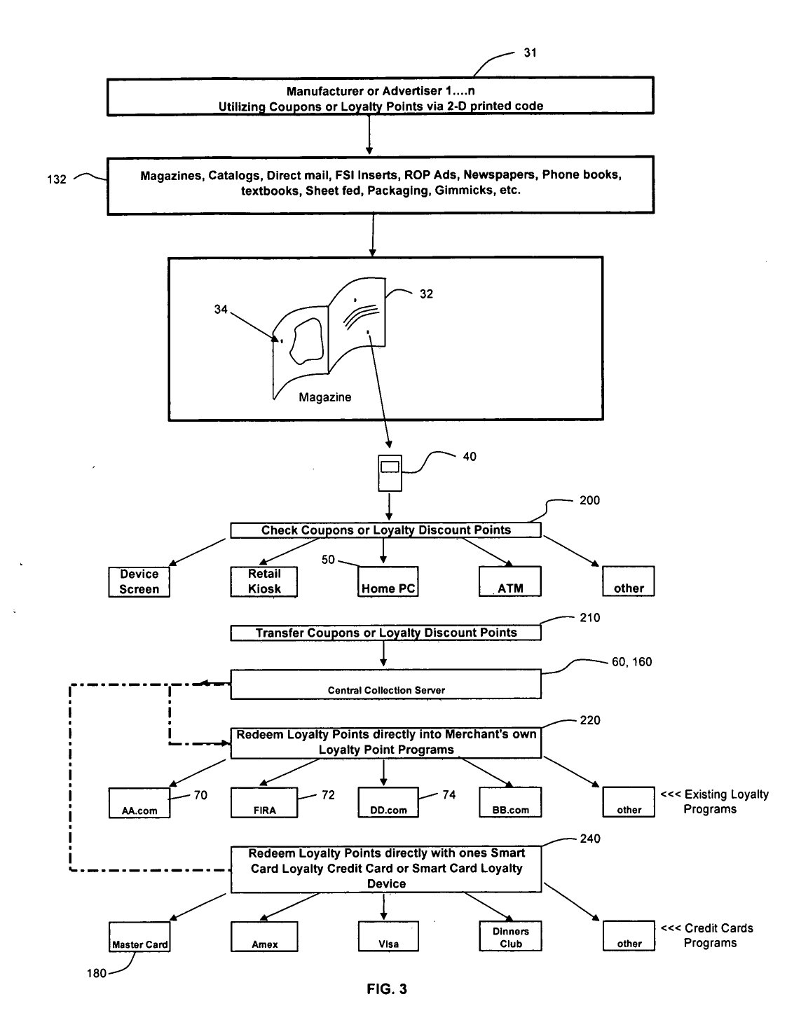

FIG. 3 shows a flow chart of the present invention. Advertisers 31 print ads and advertising data 34 in printed media 132 such as catalogs, direct mail, magazines 32 etc. Scanner 40 then scans the advertising data 34 to obtain points, which can then be checked in step 200 via for example a home PC 50, the handheld device screen or input 46, a retail kiosk, ATM or other display device, and the points transferred in step 210 to a server 60, 160. The points can then be redeemed into loyalty point programs 70, 72, 74 etc. in step 220 as described with respect to FIG. 1 or redeemed directly in step 240 via a card as described for example in FIG. 2.

The scanner may be detachable or integrated into the handheld device, and advantageously may be for example a camera of a mobile telephone. The credit or debit or other value card also can be integrated into the handheld device.

What is claimed is:

1. A method for tracking advertising effectiveness comprising:
printing advertising data with an advertisement, the advertising data identifying the advertisement, the advertising data capable of being scanned by a handheld device of a potential customer;
providing the potential customer with an incentive to scan the advertising data, the advertising data related to the incentive being stored on the handheld device after scanning by the potential customer; and
receiving the advertising data scanned by the potential customer and as a consequence crediting a loyalty point program of the potential customer.

2. The method as recited in claim 1 wherein the advertisement is printed by a first advertiser, and further comprising printing second advertising data with a second advertisement of an advertiser different from the first advertiser, and providing the potential customer with an second incentive to scan the second advertising data.

3. The method as recited in claim 2 where the advertising data is received at a server, and further comprising receiving the second advertising data scanned by the potential customer at the server.

4. The method as recited in claim 3 further comprising crediting a second loyalty point program of the potential customer with the second incentive.

5. The method as recited in claim 3 further comprising crediting the first loyalty point program of the potential customer with the second incentive.

6. The method as recited in claim 1 further comprising permitting the potential customer to redeem the incentive via an existing loyalty point program and respective loyalty card of the potential customer.

7. The method as recited in claim 1 further comprising permitting the potential customer to redeem the incentive via a credit or debit card or smart device of the customer.

8. The method as recited in claim 1 wherein the advertising data is printed in the form of a 2-D bar code

9. A system for tracking advertising effectiveness comprising:
a loyalty point collection server receiving information related to scanned advertising data of an advertiser, the scanned advertising data being stored on a plurality of handheld devices, the loyalty point collection server crediting loyalty points to loyalty point programs of users of the handheld devices as a function of the scanned advertising data, the loyalty point collection server providing information on the scanned advertising data to the advertiser.

10. A method for tracking advertising effectiveness comprising:
receiving information at a loyalty point collection server related to scanned advertising data of an advertiser, the scanned advertising data being stored on a plurality of handheld devices;
crediting loyalty points to loyalty point programs of users of the handheld devices as a function of the scanned advertising data; and
providing information on the scanned advertising data to the advertiser.

11. The method as recited in claim 10 wherein the loyalty points of the users are redeemed at a point of sale via a credit or debit card or smart device.

12. The method as recited in claim 11 further comprising providing debit liability information of the advertiser related to the loyalty points to the advertiser.

13. The method as recited in claim 10 wherein the loyalty points are stored on the handheld devices or on smart cards of the users.

14. The method as recited in claim 10 further comprising synchronizing a loyalty point collection server to a bank credit card server to validate the loyalty points.

15. The method as recited in claim 10 further comprising accepting payment by the users at a point of sale via a server.

16. The method as recited in claim 15 wherein the server stores information on issued loyalty points and debit liabilities of the advertiser.

17. The method as recited in claim 15 further comprising synchronizing a loyalty point server with the commerce server to prevent fraudulent use of the loyalty points.

18. The method as recited in claim 10 wherein the loyalty points of the users are redeemed via existing loyalty point programs and any respective loyalty card of the users with the advertiser.

19. A system for providing point of sale transactions for use with a loyalty program comprising:
a loyalty point collection server receiving information related to scanned advertising data of an advertiser, the scanned advertising data being stored on a plurality of handheld devices; and
a commerce server for clearing a sale at a point of sale, the commerce server capable of receiving payments for goods and redeeming loyalty points of users of the handheld devices.

20. The system as recited in claim 19 wherein the handheld devices or smart cards of the users store loyalty points for redemption by the commerce server.

21. The system as recited in claim 19 wherein the loyalty point collection server validates the loyalty points of the users redeemed as the commerce server.
